(19) United States
(12) Patent Application Publication
(10) Pub. No.: US 2006/0144055 A1
(43) Pub. Date: Jul. 6, 2006

(54) Display unit of air conditioner

(75) Inventor: Min Ahn, Changwon-si (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/192,273

(22) Filed: Jul. 29, 2005

(30) Foreign Application Priority Data
Dec. 30, 2004 (KR) P2004-00116243

(51) Int. Cl. G05D 23/00; F25B 49/00

(52) U.S. Cl. 62/126; 236/51

(57) ABSTRACT

Disclosed is a display unit of an air conditioner for displaying various kinds of information desired by users. The display unit of an air conditioner includes an interface for receiving information, desired by a user, from the outside of the air conditioner; and an information display panel for displaying the information transmitted through the interface, in a manner required by the user. The display unit of the air conditioner is simply used, and displays various kinds of information in the manner required by the user.

This application claims the benefit of Korean Patent Application No. P2004-116243, filed on Dec. Feb. 12, 2005, which is hereby incorporated by reference as if fully set forth herein.

### BACKGROUND OF THE INVENTION

1. Field of the Invention

The present invention relates to an air conditioner, and more particularly, to a display unit of an air conditioner, which simply displays various kinds of information to users.

2. Discussion of the Related Art

Generally, air conditioners are apparatuses for cooling/heating or conditioning air in an indoor space to provide more an exhilarating indoor environment to users. The air conditioners have a refrigerating system including a compressor, a condenser, an expansion valve, and an evaporator, and are greatly divided into split type air conditioners and integrated type air conditioners.

The spilt type air conditioner is structured such that a cooling/heating device is installed in an indoor unit, a heating/cooling device and a compressing device are installed in an outdoor unit, and the split indoor and outdoor units are connected by refrigerant pipes. The integrated type air conditioner has the same functions as those of the split type air conditioner, but is structured such that an indoor unit and an outdoor unit are integrated and is installed directly on a wall or window of a house.

FIG. 1 is a perspective view of a conventional air conditioner, and FIG. 2 is a front view of the conventional air conditioner.

As shown in FIGS. 1 and 2, the conventional air conditioner comprises a main body 1, an air blower installed in the main body 1, and a heat exchanger installed in the main body 1 for cooling or heating air.

The main body 1 includes a rear cabinet 2, the front surface of which is opened, a front cabinet 4 connected to the rear cabinet 2, and a base 3 for supporting the rear cabinet 2 and the front cabinet 4.

Air discharge ports 4a, 4b, and 4c for discharging air therethrough and air suction ports 4d and 4e for sucking air therethrough are formed through the front cabinet 4. The air discharge ports 4a, 4b, and 4c are respectively formed through the upper portions of the front and side surfaces of the front cabinet 4, and the air suction ports 4d and 4e are respectively formed through the lower portions of the side surfaces of the front cabinet 4.

A first operation panel 10 for opening and closing the front air discharge port 4a is installed on the front cabinet 4. The first operation panel 10 vertically moves, and is controlled by a control unit (not shown) provided in the main body 1. A second operation panel 12, for eliminating a difference of heights between the front cabinet 4 and the first operation panel 10 when the first operation panel 10 rises, is installed under the first operation panel 10. That is, the second operation panel 12 moves back and forth in the main body 1, thereby preventing the generation of the difference of heights between the front cabinet 4 and the first operation panel 10.

Left and right vanes 14 and 16 for opening and closing the left and right air discharge ports 4b and 4c and controlling the direction of the air discharged through the left and right air discharge ports 4b and 4c are rotatably installed in the upper portions of both side surfaces of the front cabinet 4.

A display unit 17 for displaying operational information of the air conditioner is installed on the front surface of the front cabinet 4. The display unit 17 includes a display panel 18 having a display window 18a for displaying the operational information of the air conditioner and buttons 18b for operating the air conditioner.

Since the display unit 17 of the conventional air conditioner displays only the operational information of the air conditioner, the utility of the display unit 17 is low.

### SUMMARY OF THE INVENTION

Accordingly, the present invention is directed to a display unit of an air conditioner that substantially obviates one or more problems due to limitations and disadvantages of the related art.

An object of the present invention is to provide a display unit of an air conditioner, which receives various kinds of information, desired by users, from the outside, and displays the information.

Another object of the present invention is to provide a display unit of an air conditioner, which displays information, desired by users, in various types.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a display unit of an air conditioner comprises an interface for receiving information, desired by a user, from the outside of the air conditioner; and an information display panel for displaying the information transmitted through the interface, in a manner required by the user.

Preferably, the information display panel may include a display for displaying the information; and a display main body including a display controller for controlling the display.

Further, preferably, the interface may be a USB port. More preferably, the USB port may be installed in the display controller.

Moreover, preferably, a through hole for receiving a USB connector connected to the USB port may be formed in the display main body.

Preferably, a connector insertion groove, for guiding the connected direction of the USB connector when the USB connector is connected to the USB port, may be formed in the display main body.

Further, preferably, the display controller may include a memory for storing information transmitted through the USB port.

Preferably, the display main body may further comprise a speaker for transmitting information to the user in the form of sound.

More preferably, the sound generated from the speaker may be transmitted to the outside of the air conditioner through a glass installed outside the display main body.

Preferably, the display main body may further include a control panel provided with a switch for controlling the display.

Further, preferably, the information display panel may include a display main body including a USB port; and a glass including a view window for allowing a user to view information displayed by the display main body.

Preferably, the information display panel may be rotatably installed on an air conditioner main body.

Preferably, the information display panel may further include a panel frame, on which the display main body is installed; and a glass holder for connecting the panel frame and the glass.

Further, preferably, a view window, for allowing a user to view information, desired by the user, and buttons, for operating the information display panel, may be provided on the glass.

Preferably, the glass holder may be installed along the edge of the glass, and be hinged to the air conditioner main body.

Preferably, an opening corresponding to the view window may be formed through the panel frame.

Further, preferably, the information display panel may slide on an air conditioner main.

Preferably, the display main body provided with the interface may be installed on the air conditioner main body.

In another aspect of the present invention, a display unit of an air conditioner includes an air conditioner main body including air suction ports for sucking air therethrough and air discharge ports for discharging air therethrough; a display main body including an interface for receiving information from an external peripheral device, and transmitting information to the air conditioner main body; and a glass including a view window for allowing the user at the outside to view the information displayed by the display main body.

Preferably, the interface may be a USB port.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a conventional air conditioner;

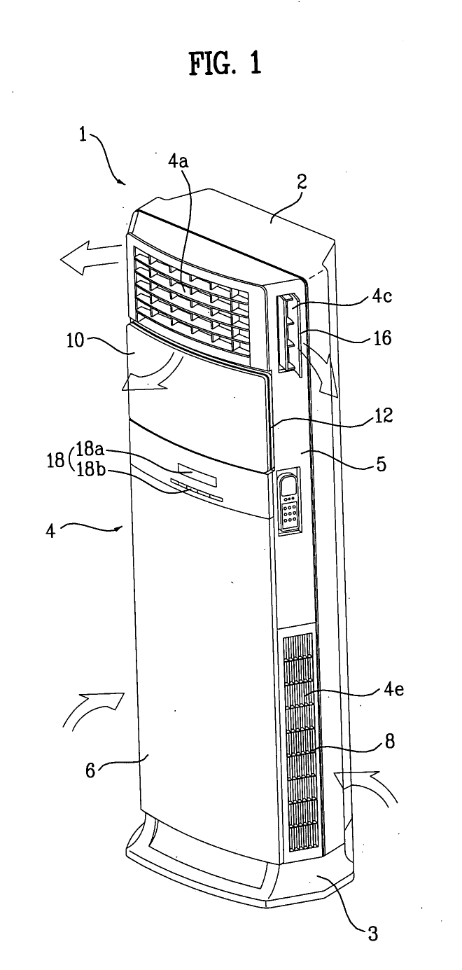

FIG. 2 is a front view of the conventional air conditioner;

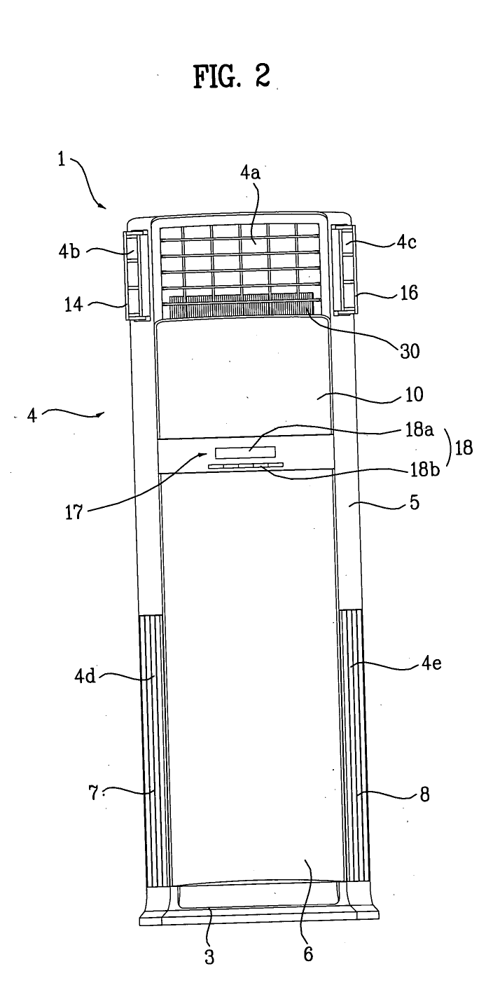

FIG. 3 is a perspective view of an air conditioner having a display unit in accordance with an embodiment of the present invention;

FIG. 4 is a perspective view of the air conditioner in a state before an information display panel shown in FIG. 3 is opened to connect a USB cable thereto;

FIG. 5 is an exploded perspective view of the information display panel shown in FIG. 3;

FIG. 6 is a front view of the air conditioner of FIG. 3;

FIG. 7 is a perspective view of the air conditioner of FIG. 3 in a stopped state;

FIG. 8 is an exploded perspective view of the air conditioner of FIG. 3; and

FIG. 9 is a sectional view of the air conditioner of FIG. 3.

### DETAILED DESCRIPTION OF THE INVENTION

Reference will now be made in detail to the preferred embodiment of the present invention, examples of which are illustrated in the accompanying drawings. Wherever possible, the same reference numbers will be used throughout the drawings to refer to the same or like parts.

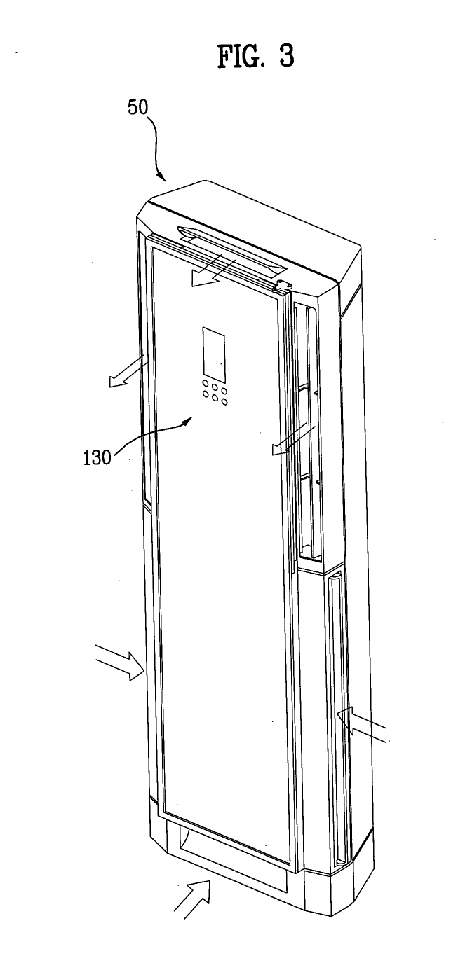

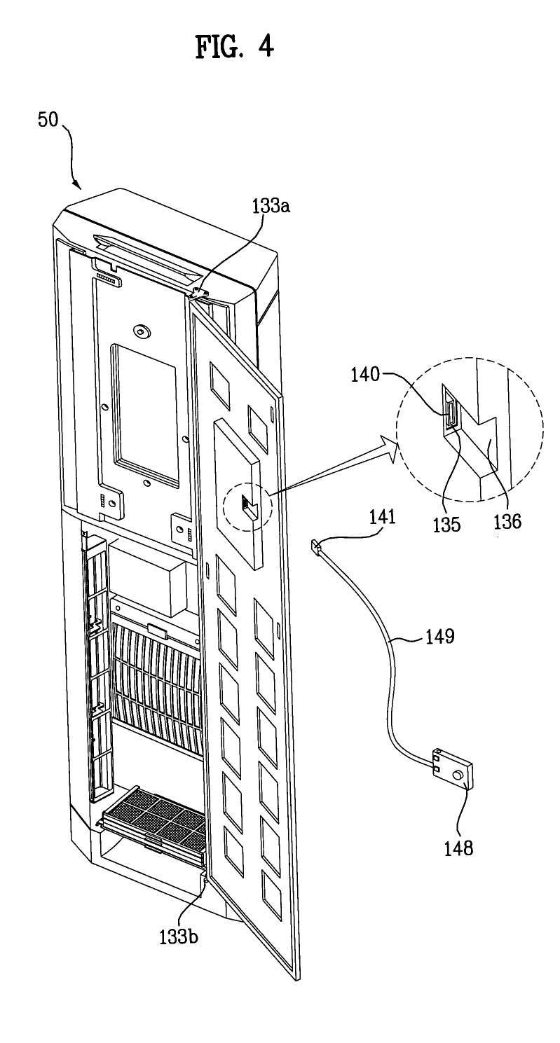

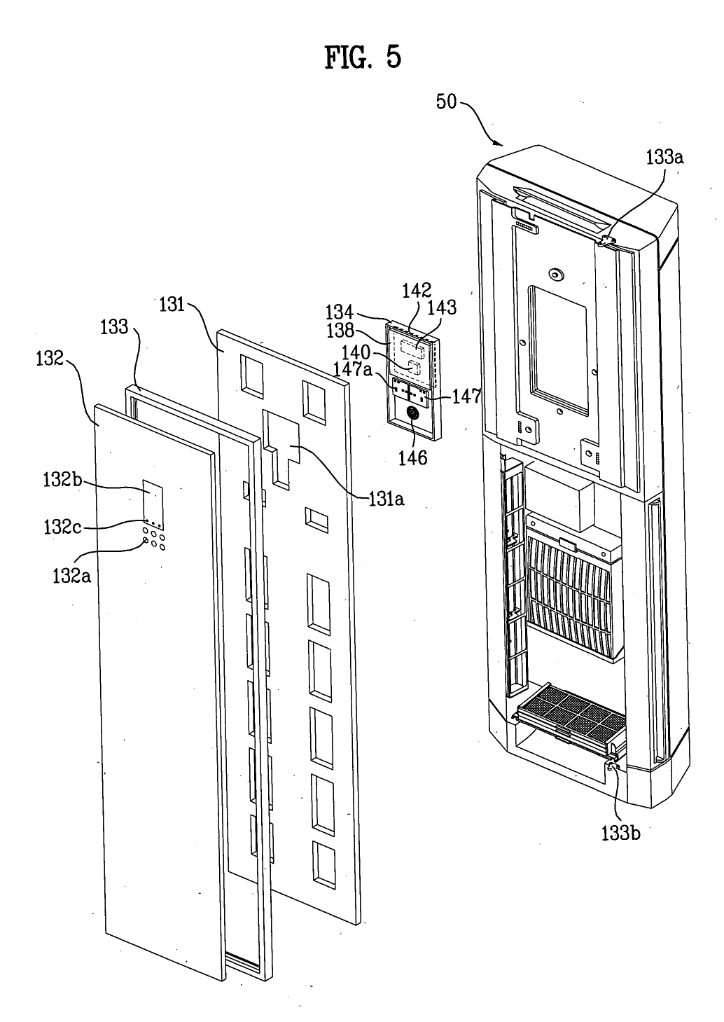

FIG. 3 is a perspective view of an air conditioner having a display unit in accordance with an embodiment of the present invention, FIG. 4 is a perspective view of the air conditioner in a state before an information display panel shown in FIG. 3 is opened to connect a USB cable thereto, and FIG. 5 is an exploded perspective view of the information display panel shown in FIG. 3.

The air conditioner of the present invention comprises an information display panel 130 installed on a main body 50, and an interface installed on the information display panel 130.

The interface serves to receive information, which is desired by a user, from the outside of the air conditioner. Preferably, a universal serial bus (USB) port 140 is used as the interface.

USB is one type of series interface methods used in personal computers, and is the most universal bus standard, which was developed to provide interconnection.

The information display panel 130 serves to display information, transmitted through the interface, in a manner required by the user.

The information display panel 130 includes a display main body 134 for displaying the information desired by the user, and a panel frame 131, on which a glass 132, for showing the information displayed by the display main body 134, and the display main body 134 are installed.

The display main body 134 includes a display 138 for displaying the information, and a display controller 142 for controlling the display 138.

Preferably, a liquid crystal display (LCD) is used as the display 138. However, the display 138 is not limited thereto, and may include any display means, capable of displaying information to users. The display controller 142 serves to control the display 138 such that the display 138 displays corresponding information when a user inputs a designated signal in order to obtain the information. The USB port 140 is installed in the display controller 142.

A memory 143 for storing information transmitted through the USB port 140 is installed on the display main body 134.

A through hole 135 for receiving a USB connector 141 connected to the USB port 140 is formed in the display main body 134. A connector insertion groove 136, for guiding the connected direction of the USB connector 141 when the USB connector 141 is connected to the USB port 140, is formed at the front end of the through hole 135. The connector insertion groove 136 also serves to protect the USB connector 141.

The USB connector 141 is connected to a USB cable 149, and the USB cable 149 is connected to a peripheral device 148, such as a digital camera, for storing data including photographs or moving pictures, or a MP3.

A speaker 146 for transmitting the information, desired by the user, as sound is installed on the display main body 134. The sound generated from the speaker 146 is transmitted to the outside of the air conditioner through the glass 132 installed outside the display main body 134. The sound may be a voice of a person, or a sound of a general organism or abiotic object.

A control panel 147 provided with a switch 147a for controlling the display 138 is installed on the display main body 134. When the switch 147a of the control panel 147 is operated, the display controller 142 substantially controls the display 138 by means of a signal inputted through the switch 147a. Of course, a switch for controlling the air conditioner main body 50 may be installed on the control panel 147.

The panel frame 131 for mounting the display main body 134 thereon is installed in front of the display main body 134 provided with the USB port 140.

The panel frame 131 serves to support the glass 132, and an opening 131a having a designated shape is formed through the panel frame 131. The opening 131a corresponds to a view window 132b formed through the glass 132.

The user can view the information displayed by the display main body 134 through the view window 132b and the opening 131a. That is, the display main body 134 is installed on the rear surface of the panel frame 131 so that the information of the display 138 is displayed through the opening 131a and the view window 132b.

The glass 132 includes the view window 132b for viewing the information displayed by the display main body 134, and at least one button 132a for controlling the information display panel 130. The glass 132 further includes through holes 132c serving as channels for transmitting the sound generated from the speaker 146 of the display main body 134 to the outside.

A glass holder 133 for connecting the panel frame 131 and the glass 132 is installed between the panel frame 131 and the glass 132. The glass holder 133 is installed along the outer edge of the glass 132, and is hinged to the air conditioner main body 50. That is, the information display panel 130 is rotatably installed on the air conditioner main body 50.

More specifically, one side of the upper end of the glass holder 133 is connected to an upper hinge bracket 133a, fixed to the upper part of the air conditioner main body 50 by screws, and one side of the lower end of the glass holder 133 is connected to a lower hinge bracket 133b, fixed to the lower part of the air conditioner main body 50 by screws.

That is, the information display panel 130 opens and shuts the central area of the front surface of the air conditioner main body 50 centering on the upper hinge bracket 133a and the lower hinge bracket 133b.

The connection between the information display panel 130 and the air conditioner main body 50 of the present invention is not limited thereto. That is, the information display panel 130 may be slidably connected to the air conditioner main body 50 50.

More specifically, rails (not shown) having a designated shape may be respectively installed on the upper and lower ends of the air conditioner main body 50, and a panel driving device (not shown) for driving the information display panel 130 may be installed in the air conditioner main body 50.

When the information display panel 130 receives necessary information from the outside, the information display panel 130 is slid towards the side surface of the air conditioner by the panel driving device.

The display main body 134 is installed on the air conditioner main body 50, and the USB port 140 is installed in the display main body 134. More particularly, preferably, the USB port 140 is installed in the front surface of the air conditioner main body 50 in order to facilitate the connection between the USB port 140 and the USB connector 141, and the through hole 135 for receiving the USB connector 141 and the connector insertion groove 136 are formed in the display main body 134 in order to correspond to the USB connector 141.

Hereinafter, the operation of the above display unit of the air conditioner of the present invention will be described.

First, when the information display panel 130 is rotated to be distant from the front surface of the air conditioner main body 50, as shown in FIG. 4, the display main body 134 of the information display panel 130 is exposed to the outside.

When the USB cable 149 is connected to the peripheral device 148 storing photographs or moving pictures, and the USB connector 141 of the USB cable 149 is sequentially inserted into the connector insertion groove 136 and the through hole 135 formed in the display main body 134, the USB connector 141 is connected to the USB port 140.

Thereafter, when the peripheral device 148 is manipulated such that the peripheral device 148 reaches a data transmission mode, the data, such as photographs or moving pictures, stored in the peripheral device 148 are transmitted to the memory 143 through the USB cable 149, the USB connector 141, and the USB port 140, and are stored in the memory 143.

When the USB cable 149 is pulled after the data, such as photographs or moving pictures, are stored in the memory 143, the USB cable 149 is separated from the USB port 140.

Thereafter, when the information display panel 130 is rotated to contact the front surface of the air conditioner main body 50, as shown in FIG. 3, the display main body 134 is positioned between the front surface of the air conditioner main body 50 and the rear surface of the panel frame 131, and is not exposed to the outside of the air conditioner.

Then, when a user operates the button 132a of the glass or a separate remote handling device (not shown), the display controller 142 controls the display 138, the display 138 displays data, such as photographs or moving pictures, and the data are displayed on the front surface of the air conditioner through the glass 132.

The air conditioner can display various operational information of the air conditioner, such as cooling operation/dehumidifying operation, in character or avatar as well as display photographs or moving pictures as described above. Further, the air conditioner provides various kind of sound information, such as birthday-congratulating massages or music, through the speaker 146.

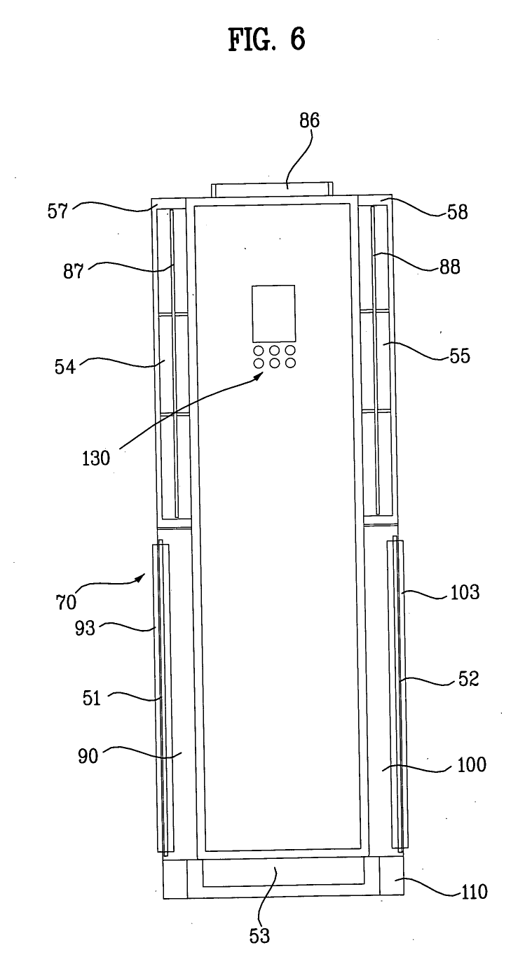

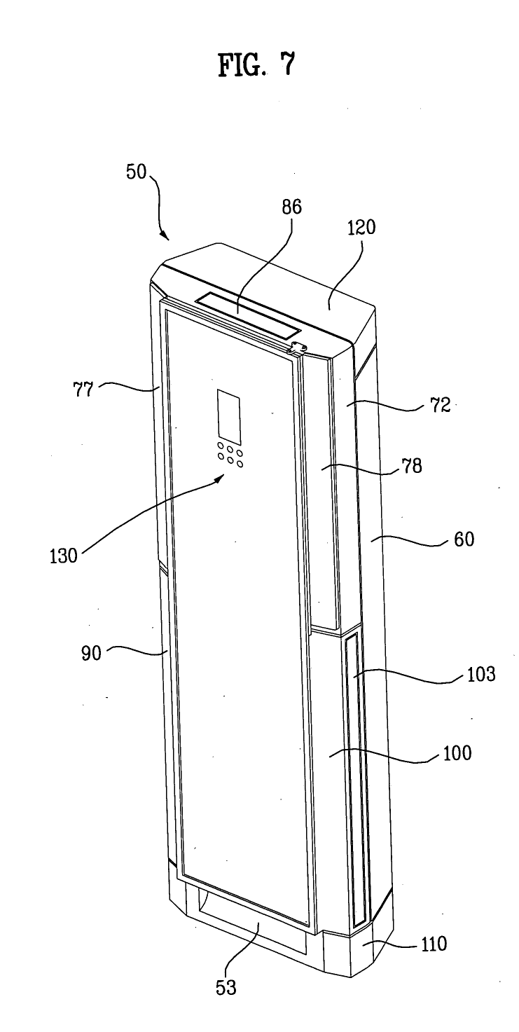

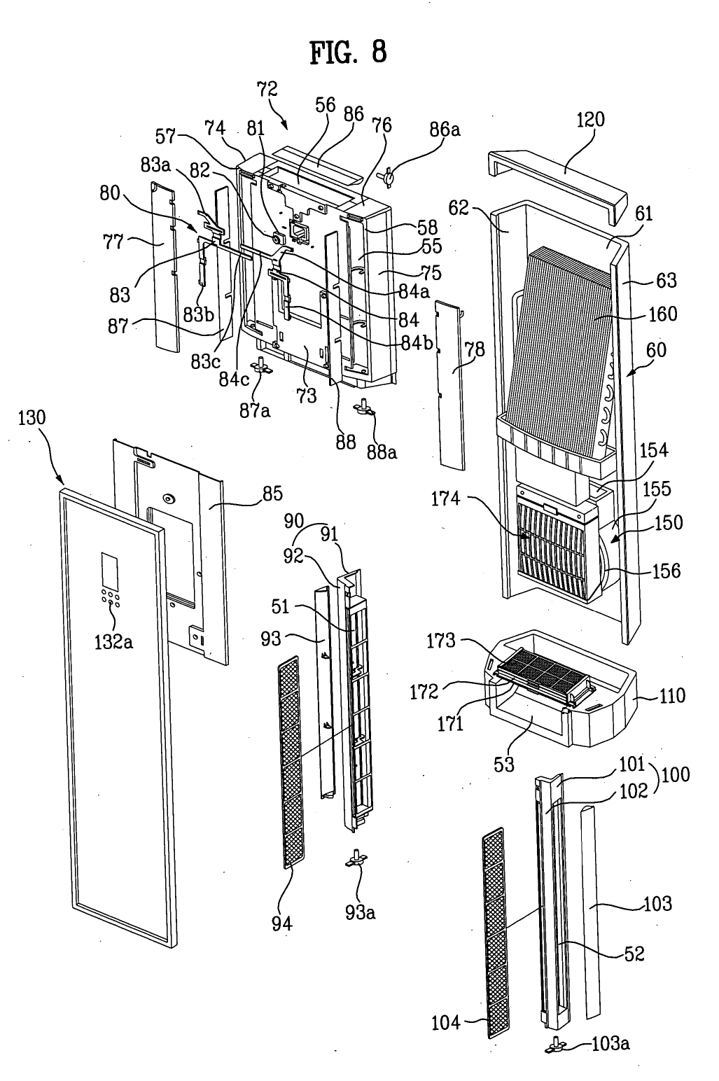

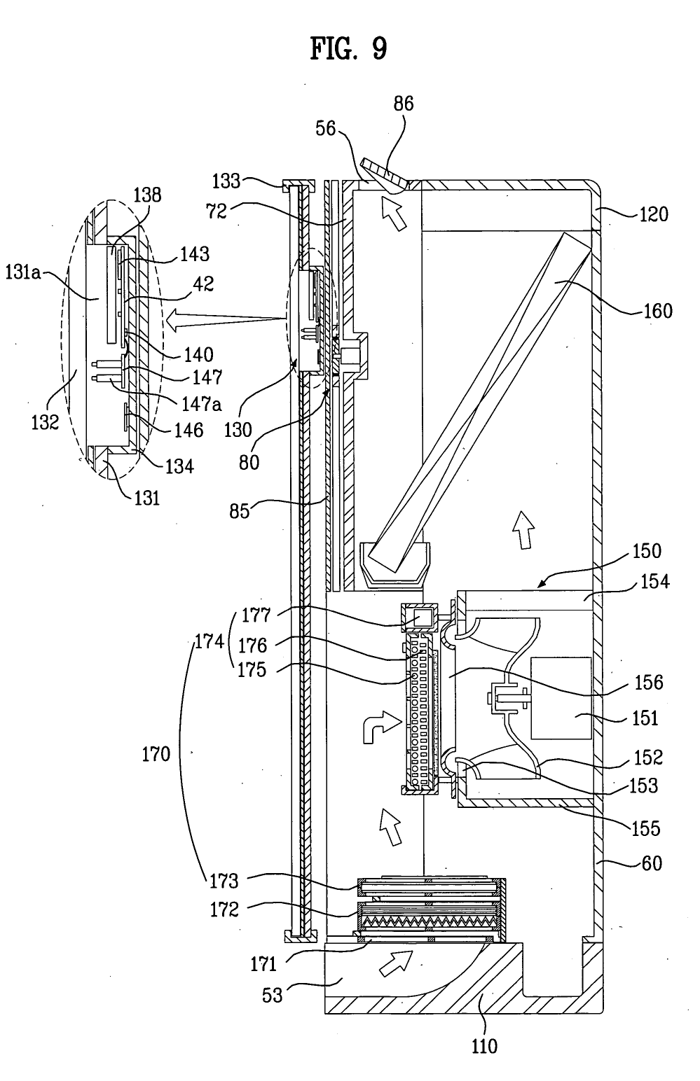

FIG. 6 is a front view of the air conditioner of FIG. 3, FIG. 7 is a perspective view of the air conditioner of FIG. 3 in a stopped state, FIG. 8 is an exploded perspective view of the air conditioner of FIG. 3, and FIG. 9 is a sectional view of the air conditioner of FIG. 3. Air suction ports 51 and 52 for sucking indoor air therethrough are formed through the lower part of the air conditioner main body 50. The air suction ports 51 and 52 include a left air suction port 51 formed through the left side surface of the lower part of the air conditioner main body 50, and a right air suction port 52 formed through the right side surface of the lower part of the air conditioner main body 50. Further, a front air suction port 53 is formed through the front surface of the lower part of the air conditioner main body 50.

Air discharge ports 54 and 55 for discharging air therethrough are formed through both sides of the front surface of the upper part of the air conditioner main body 50. The air discharge ports 54 and 55 include a left air discharge port 54 formed through the left side of the front surface of the upper part of the air conditioner main body 50, and a right air discharge port 55 formed through the right side of the front surface of the upper part of the air conditioner main body 50. Further, an upper air discharge port 56 is formed through the upper surface of the air conditioner main body 50.

Both inclined side planes 57 and 58 are formed at the sides of the front surface of the air conditioner main body 50. Preferably, the inclined side planes 57 and 58 have an angle of 20° or less.

The left air discharge port 54 is longitudinally formed through the left inclined side plane 57 of the air conditioner main body 50. The right air discharge port 55 is longitudinally formed through the right inclined side plane 58 of the air conditioner main body 50.

The air conditioner main body 50 includes a rear cabinet 60, the front surface of which is opened, and a front cabinet 70 positioned in front of the rear cabinet 60.

The rear cabinet 60, as shown in FIG. 8, includes a rear surface 61, a left side surface 62 inclined forwardly from the left side end of the rear surface 61 at a designated angle, and a right side surface 63 inclined forwardly from the right side end of the rear surface 61 at a designated angle.

The air conditioner main body 50 further includes a base 110, on which the rear cabinet 60 is installed. The front air suction port 53 is formed through the base 110.

The front air suction port 53, as shown in FIG. 9, has a rounded shape from the front surface of the base 110 to the upper surface of the base 110.

The lower end of the rear cabinet 60 is mounted on the upper surface of the base 110, and the rear cabinet 60 is fixed to the base 110 by fixing means, such as screws. More specifically, the rear cabinet 60 is vertically installed on the base 110.

The air conditioner main body 50 further comprises an upper panel 120 installed on the rear cabinet 60 for closing the opened upper surface of the rear cabinet 60.

The left and right air suction ports 51 and 52 are formed through both side surfaces of the lower part of the front cabinet 70, and the left and right air discharge ports 54 and 55 are formed through both sides of the front surface of the upper part of the front cabinet 70.

The front cabinet 70 includes an upper panel 72 forming the upper part of the front cabinet 70, and lower panels 90 and 100 positioned under the upper panel 72.

The upper panel, as shown in FIG. 8, includes a front surface 73 on which the left inclined side plane 57 and the right inclined side plane 58 are formed, a left side surface 74 perpendicularly bent or inclined backwardly from the left side end of the left inclined side plane 57, a right side surface 75 perpendicularly bent or inclined backwardly from the right side end of the right inclined side plane 58, and an upper surface 76 formed on the upper ends of the front surface 73, the left side surface 74, and the right side surface 75.

The upper air discharge port 56 is laterally formed through the upper surface 76.

A left door 77 for opening and closing the left air discharge port 54 and a right door for opening and closing the right air discharge port 55 are installed on the front surface of the upper panel 72 such that the left and right doors 77 and 78 can slide in the lateral direction.

The left door 77 installed on the front surface of the upper panel 72 slides in the lateral direction along the front surface of the upper panel 72, thereby opening and closing the left air discharge port 54. The right door 78 installed on the front surface of the upper panel 72 slides in the lateral direction along the front surface of the upper panel 72, thereby opening and closing the right air discharge port 55. A door-driving device 80 for controlling the left and right doors 77 and 68 is installed on the front surface of the upper panel 72.

The door-driving device 80 includes a motor 81 installed at the central area of the front surface of the upper panel 72, a pinion 82 installed on a rotary shaft of the motor 81, a left driving member 83 toothed with the pinion 82 and connected to the left door 77, and a right driving member 84 toothed with the pinion 82 and connected to the right door 78.

The left driving member 83 includes a plurality of left arms 83a and 83b connected to the left door 77, and a left rack 83c formed integrally with the left arms 83a and 83b and extended below the pinion 82 to be toothed with the pinion 82.

The right driving member 84 includes a plurality of right arms 84a and 84b connected to the right door 78, and a right rack 84c formed integrally with the right arms 84a and 84b and extended above the pinion 82 to be toothed with the pinion 82.

A front cover 85 for covering the front surface of the upper panel 72 and protecting the door-driving device 80 is installed in front of the upper panel 72.

An upper door 86 for opening and closing the upper air discharge port 56 is rotatably installed on the upper surface 76 of the upper panel 72.

An upper door motor 86a for rotating the upper door 86 is installed below the upper surface 76 of the upper panel 72.

A left discharge vane 87, for adjusting the direction of air discharged through the left air discharge port 54, and a left discharge vane driving motor 87a, for rotating the left discharge vane 87 are installed at the left side of the upper panel 72.

A right discharge vane 88, for adjusting the direction of air discharged through the right air discharge port 55, and a right discharge vane driving motor 88a, for rotating the right discharge vane 88 are installed at the right side of the upper panel 72.

The lower panels 90 and 100 include a left lower panel 90 positioned between the left inclined plane 57 of the upper panel 72 and the upper surface of the base 110 and between the left side surface 74 of the upper panel 72 and the upper surface of the base 110, and a right lower panel 100 positioned between the right inclined plane 59 of the upper panel 72 and the upper surface of the base 110 and between the right side surface 75 of the upper panel and the upper surface of the base 110.

The left lower panel 90 includes a left side surface 91 positioned between the left side surface 74 of the upper panel 72 and the upper surface of the base 110, and a front surface 92 positioned between the left inclined plane 57 of the upper panel 72 and the upper surface of the base 110.

The left air suction port 51 is longitudinally formed through the left side surface 91 of the left lower panel 90.

A left suction vane 93, for opening and closing the left air suction port 51 and guiding indoor air sucked through the left air suction port 51, and a left suction vane driving motor 93a, for rotating the left suction vane 93, are installed on the left lower panel 90.

The front surface 92 of the left lower panel 90 is inclined at a designated angle like the left inclined plane 57 of the upper panel 72.

A left pre-filter 94 for filtering out dust from the air sucked through the left air suction port 51 is installed on the left lower panel 90.

The right lower panel 100 includes a right side surface 101 positioned between the right side surface 75 of the upper panel 72 and the upper surface of the base 110, and a front surface 102 positioned between the right inclined plane 58 of the upper panel 72 and the upper surface of the base 110.

The right air suction port 52 is longitudinally formed through the right side surface 101 of the right lower panel 100.

A right suction vane 103, for opening and closing the right air suction port 52 and guiding indoor air sucked through the right air suction port 52, and a right suction vane driving motor 103a, for rotating the right suction vane 103, are installed on the right lower panel 100.

The front surface 102 of the right lower panel 100 is inclined at a designated angle like the right inclined plane 58 of the upper panel 72.

A right pre-filter 104 for filtering out dust from the air sucked through the right air suction port 52 is installed on the right lower panel 100.

An air blower 150, a heat exchanger 160, and an air purifier 170 are installed on the air conditioner main body 50, as shown in FIGS. 8 and 9.

The air blower 150 includes an air blowing motor 151 installed in front of the rear surface of the rear cabinet 60, a turbo-fan 152 installed on a rotary shaft of the air blowing motor 151, a fan housing 155 surrounding the turbo-fan 152 and provided with an opening 153 formed through the front surface thereof and a discharge hole 154 formed through the upper surface thereof, and an orifice 156 installed on the front surface of the fan housing 155 so as to be positioned at the opening 155.

The heat exchanger 160 is slantingly positioned between the lower part of the upper panel 72 and the upper part of the rear cabinet 60.

The air purifier 700, as shown in FIGS. 8 and 9, includes a plurality of filters 171, 172, and 173 installed above the front air suction port 53 formed through the base 110, and an electric dust collector 174 installed in front of the orifice 156.

The filters 171, 172, and 173 include a lower pre-filter 171 for filtering out dust from air, a HEPA filter 172 installed above the lower pre-filter 171 for filtering out fine dust from the air, and a nano filter 173 installed above the HEPA filter 172 for eliminating odor particles and bacteria from the air.

The electric dust collector 174 includes an ionizer 175 for ionizing dust of air, a dust collector 176 for collecting the dust ionized by the ionizer 175, and a high-voltage generator 177 for applying high voltage to the ionizer 175 and the dust collector 176.

When the above air conditioner is operated in cooling or heating mode, as shown in FIG. 3, the left suction vane driving motor 93a and the right suction vane driving motor 103a are driven in an opened mode, and the left air suction port 51 and the right air suction port 52 are opened.

When the motor 81 of the door-driving device 80 is driven in an opened mode to rotate the pinion 82 in the counterclockwise direction, the left driving member 83 slides to the right to open the left air discharge port 54 and the right driving member 84 slides to the left to open the right air discharge port 55.

Further, the upper door motor 86a is driven in an opened mode to open the upper air discharge port 56, as shown in FIG. 3.

When the air blowing motor 151 is driven, indoor air is sucked into the air conditioner main body 50 through the left air suction port 51, the right sir suction port 52, and the front air suction port 53.

The indoor air sucked through the left air suction port 51 passes through the left pre-filter 94 so that coarse dust is filtered out of the indoor air, and the indoor air sucked through the right air suction port 52 passes through the right pre-filter 104 so that coarse dust is filtered out of the indoor air.

The indoor air sucked through the front air suction port 53 passes through the lower pre-filter 171 so that coarse dust is filtered out of the indoor air, passes through the HEPA filter 172 so that fine dust is filtered out of the air, and then passes through the nano filter 173 so that odor particles or bacteria are eliminated from the air.

The purified indoor air sequentially passes through the ionizer 175, the dust collector 176, the orifice 156, and the fan housing 155, and is blown above the fan housing 155.

The air blown above the fan housing 155 passes through the heat exchanger 160 to exchange heat with a refrigerant, thereby being cooled or heated.

A small portion of the above cooled or heated indoor air is blown to the front portion of the upper part of the air conditioner main body 50 through the upper air discharge port 56, and a large portion of the cooled or heated indoor air is blown to the front portion of the air conditioner main body 50 through the left air discharge port 54 and the right air discharge port 55.

When the above air conditioner is operated in an air cleaning mode, the left suction vane driving motor 93a and the right suction vane driving motor 103a are driven in a closed mode, and the left air suction port 51 and the right air suction port 52 are closed.

When the motor 81 of the door-driving device 80 is driven in a closed mode to rotate the pinion 82 in the clockwise direction, the left driving member 83 slides to the left to close the left air discharge port 54 and the right driving member 84 slides to the right to close the right air discharge port 55.

On the other hand, the upper door motor 86a is driven in an opened mode to open the upper air discharge port 56. The high voltage generated from the high-voltage generator 177 is applied to the ionizer 175 and the dust collector 176, and the air blowing motor 151 is driven.

When the air blowing motor 151 is driven, indoor air is sucked into the air conditioner main body 50 through the front air suction port 53.

The indoor air sucked through the front air suction port 53 passes through the lower pre-filter 171 so that coarse dust is filtered out of the indoor air, passes through the HEPA filter 172 so that fine dust is filtered out of the air, and then passes through the nano filter 173 so that odor particles or bacteria are eliminated from the air.

The purified indoor air sequentially passes through the ionizer 175 and the dust collector 176 of the dust collector 174 so that dust out of the air is ionized and collected, sequentially passes through the orifice 156 and the fan housing 155 of the dust collector 174, and is then blown above the fan housing 155.

The air blown above the fan housing 155 passes through the heat exchanger 160 without exchanging heat with a refrigerant, and is then concentrically blown to the front portion of the upper part of the air conditioner main body 50.

When the operation of the air conditioner is stopped, as shown in FIG. 6, the left suction vane driving motor 93a and the right suction vane driving motor 103a are driven in a closed mode, and the left air suction port 51 and the right air suction port 52 are closed.

Then, when the motor 81 of the door-driving device 80 is driven in a closed mode to rotate the pinion 82 in the clockwise direction, the left driving member 83 slides to the left to close the left air discharge port 54, and the right driving member 84 slides to the right to close the right air discharge port 55. On the other hand, the upper door motor 86a is driven in a closed mode to close the upper air discharge port 56.

The above-described display unit of the air conditioner of the present invention receives information, such as photographs or moving pictures, from a peripheral device through a USB port, thereby providing various kind of information to users.

Since an information display panel of the display unit of the air conditioner of the present invention is rotatably installed in an air conditioner main body, the connection between the display unit and a USB connector is facilitated.

Since the USB port of the display unit of the air conditioner of the present invention is installed in a display controller, a separate signal line for connecting the USB port and the display controller is not required.

Since a through hole and a connector insertion groove for receiving the USB connector connected to the USB port are formed in the display unit of the air conditioner of the present invention, the display unit is conveniently used when the display unit receives information transmitted through the USB port.

The display unit of the air conditioner of the present invention includes a speaker installed on a display main body, thereby being capable of displaying various massages and operational information of the air conditioner as sound.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A display unit of an air conditioner comprising:
an interface for receiving information desired by a user from the outside of the air conditioner; and
an information display panel for displaying the information transmitted through the interface, in a manner required by the user.

2. The display unit as set forth in claim 1, wherein the information display panel comprises:
a display for displaying the information; and
a display main body including a display controller for controlling the display.

3. The display unit as set forth in claim 2, wherein the interface is a USB port.

4. The display unit as set forth in claim 3, wherein the USB port is installed in the display controller.

5. The display unit as set forth in claim 3, wherein a through hole for receiving a USB connector connected to the USB port is formed in the display main body.

6. The display unit as set forth in claim 5, wherein a connector insertion groove, for guiding the connected direction of the USB connector when the USB connector is connected to the USB port, is formed in the display main body.

7. The display unit as set forth in claim 4, wherein the display controller includes a memory for storing information transmitted through the USB port.

8. The display unit as set forth in claim 3, wherein the display main body further comprises a speaker for transmitting information to the user in the form of sound.

9. The display unit as set forth in claim 8, wherein the sound generated from the speaker is transmitted to the outside of the air conditioner through a glass installed outside the display main body.

10. The display unit as set forth in claim 3, wherein the display main body further comprises a control panel provided with a switch for controlling the display.

11. The display unit as set forth in claim 1, wherein the information display panel comprises:
a display main body including a USB port; and
a glass including a view window for allowing a user to view information displayed by the display main body.

12. The display unit as set forth in claim 11, wherein the information display panel is rotatably installed on an air conditioner main body.

13. The display unit as set forth in claim 11, wherein the information display panel further comprises:
a panel frame, on which the display main body is installed; and
a glass holder for connecting the panel frame and the glass.

14. The display unit as set forth in claim 13, wherein a view window for allowing a user to view information desired by the user and buttons for operating the information display panel, are provided on the glass.

15. The display unit as set forth in claim 13, wherein the glass holder is installed along the edge of the glass, and is hinged to the air conditioner main body.

16. The display unit as set forth in claim 13, wherein an opening corresponding to the view window is formed through the panel frame.

17. The display unit as set forth in claim 2, wherein the information display panel slides on an air conditioner main body.

18. The display unit as set forth in claim 17, wherein the display main body provided with the interface is installed on the air conditioner main body.

19. A display unit of an air conditioner comprising:
an air conditioner main body including air suction ports for sucking air therethrough and air discharge ports for discharging air therethrough;
a display main body including an interface for receiving information from an external peripheral device and transmitting information to the air conditioner main body; and
a glass including a view window for allowing the user at the outside to view the information displayed by the display main body.

20. The display unit as set forth in claim 19, wherein the interface is a USB port.
